(19) United States
(12) Patent Application Publication
(10) Pub. No.: US 2004/0250054 A1
(43) Pub. Date: Dec. 9, 2004

(54) Line prediction using return prediction information

(76) Inventor: Jared W. Stark, Portland, OR (US)

Correspondence Address: Blakely, Sokoloff, Taylor & Zafman, Seventh Floor, 12400 Wilshire Boulevard, Los Angeles, CA, 90025-1030, US

(21) Appl. No.: 10/458,333

(22) Filed: Jun. 9, 2003

(51) Int. Cl. G06F 9/00

(52) U.S. Cl. 712/239; 712/242

(57) ABSTRACT

A method, apparatus, and system are provided for performing line predictions using return prediction information. According to one embodiment, a return predictor is monitored and snooped. The snooping of the return prediction includes reading a prediction from the return predictor.

### BACKGROUND OF THE INVENTION

1. Field of the Invention

This invention relates generally to the field of line prediction and more particularly, to improving line prediction using return prediction information.

2. Description of the Related Art

Early microprocessors generally processed instructions one at a time. Each instruction was processed using separate sequential stages (e.g., instruction fetch, decode, execute, and result writeback). In such microprocessors, different dedicated logic blocks performed each of the different processing stages. Each logic block waited until all the previous logic blocks completed operations before beginning its operation.

To improve efficiency, microprocessor designers overlapped the operations of the logic blocks for the instruction processing stages such that the microprocessor operated on several instructions simultaneously. In operation, the logic blocks and the corresponding instruction processing stages concurrently process different instructions. At each clock tick, the result of each processing stage is passed to the subsequent processing stage. Microprocessors that use the technique of overlapping instruction processing stages are known as “pipelined” microprocessors. Some microprocessors, such as “deeply pipelined” microprocessors, further divide each processing stage into substages for additional performance improvement.

In a typical pipelined processor, the fetch unit at the head of the pipeline provides the pipeline with a continuous flow of instructions, hence keeping the microprocessor busy. The fetch unit keeps the constant flow of instructions so the microprocessor does not have to stop its execution to fetch an instruction from memory. Such fetching guarantees continuous execution, as long as the instructions are stored in order of execution. However, due to certain instructions, such as conditional instructions included in software loops or conditional jumps, instructions encountered by the fetch unit are not always presented in a sequence corresponding to the order of execution. Thus, such instructions can cause pipelined microprocessors to speculatively execute down the wrong path such that the microprocessor must later flush the speculatively executed instructions and restart at a corrected address. In many of the pipelined microprocessors, a line predictor sits at the beginning of the pipeline and provides an initial prediction about which instructions to fetch next. However, to supply the microprocessor's execution core with enough useful instructions, the line predictor's bandwidth, i.e., predictions per cycle, and accuracy must be relatively high.

As microprocessor cycle time shrinks, accurate line prediction becomes more important, and at the same time, a more difficult and challenging task to perform within a fixed number of cycles. With today's microprocessors having reduced cycle time, maintaining and providing new instructions has become relatively difficult and cumbersome, which results in reduced machine efficiency. With lower bandwidth, line prediction accuracy bubbles enter the pipeline, resulting in lower machine performance.

FIG. 1 is a block diagram illustrating a prior art baseline line predictor. A typical line predictor 100 may work like an indexed table to provide an address to be fed back into the indexed table in the next cycle. For example, when an address is logged into the table, the line predictor 100 provides what may be the next address to fetch. Mostly, sequential instruction cache line addresses are be fetched, so instead of caching all of the elements, only the non-sequential addresses may be cached. Stated differently, a Fetch Program Counter (PC) 104 may be indexed into the line predictor (LP) Cache 102. If there is a hit in the LP Cache 102, the line is predicted to be non-sequential, the LP Cache 102 provides the target address in the target field 106, which may be the LP Next Fetch PC 108. The LP Cache hit represents that a target address from the target field 106 is selected. On the other hand, in case of a miss in the LP Cache 102, the line is predicted to be sequential, and the next sequential line represents the address to be selected. The tag 104 of the LP Cache 102 may indicate the LP Cache 102 hit or miss.

The Increment logic 110 may take the Fetch PC 204 and compute the address of the next sequential instruction cache line. The LP Cache 102 may cache non-sequential line predictions. On a cache miss, the line may be predicted to be sequential. On a cache hit, the target field 106 may provide the LP Next Fetch PC 108.

Typically, when a misprediction occurs, i.e., when a line predictor 100 prediction (simple prediction), or the LP Next Fetch PC 108 prediction, mismatches the Front-End Next Fetch PC (FE Next Fetch PC) Calculation Unit prediction (complex prediction), the calculated complex prediction, which is regarded as more accurate, may be written into the target field 106, and the entire prediction mechanism may be retrained according to the complex prediction. Also, as an exception, in case of a line misprediction and the complex prediction being a sequential prediction, sequential address may be written into the LP Cache 102. The LP Cache 102 retains the sequential address until it is replaced by a non-sequential address or prediction. Stated differently, the LP Cache 102 continues to cache a few sequential line predictions until they are replaced by non-sequential predictions.

None of the methods, apparatus, and systems available today provide the accuracy and bandwidth necessary for a line predictor to perform at the level required, particularly with regard to reduced clock cycle microprocessors. Clock cycle or cycle time refers to time intervals allocated to various states of an instruction processing pipeline within the microprocessor. Furthermore, although many of the mispredictions in a typical line prediction mechanism are caused by subroutine returns, none of the conventional line predictors provide monitoring and/or snooping a return predictor to determine whether a subroutine return may be predicted, i.e., whether the next non-sequential line prediction is due to a subroutine return. A subroutine may refer to instructions to perform a function, and a subroutine return may refer to an instruction having a target address corresponding to one instruction after the last or most recently executed call instruction.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a prior art baseline line predictor;

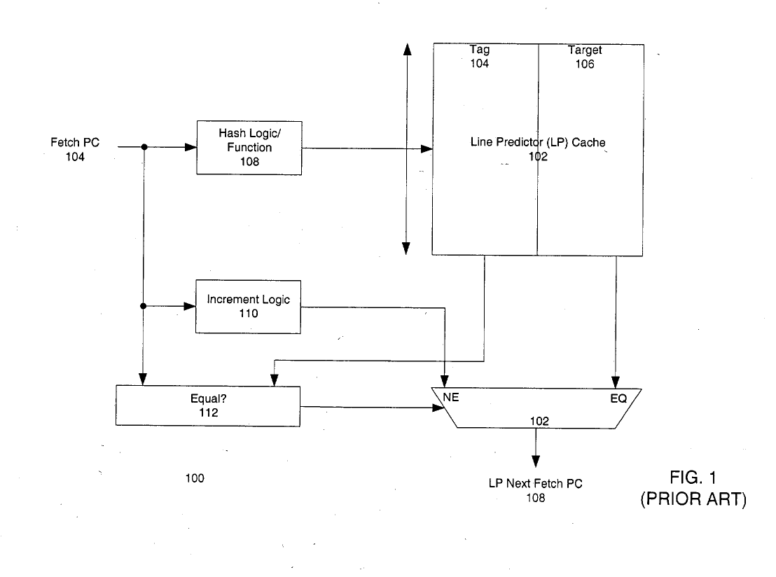

FIG. 2 is a block diagram illustrating a simplified instruction pipeline;

FIG. 3 is a block diagram illustrating an overview of front-end pipeline stages;

FIG. 4 is a block diagram illustrating an embodiment of a computer system;

FIG. 5 is block diagram illustrating an embodiment of a microprocessor having a line prediction circuit;

FIG. 6 is a block diagram illustrating an embodiment of a line prediction circuit;

FIG. 7 is a flow diagram illustrating an embodiment of a line prediction process; and

FIG. 8 is a flow diagram illustrating an embodiment of a process when a delay in return predictor updates may be experienced.

### DETAILED DESCRIPTION

A method, apparatus, and system are described for improving line prediction using a return predictor. Broadly stating, a line predictor monitors and snoops the return predictor to improve the overall line prediction.

According to one embodiment, a line predictor may monitor and snoop a return predictor to read the next prediction from the return predictor. The return predictor may include a return prediction stack (RPS) having return addresses including both the predicted and actual return addresses. According to one embodiment, monitoring the return predictor may include the line predictor monitoring the RPS of the return predictor. According to one embodiment, a bit (e.g., a single bit or an extra bit) may be included in the line predictor (LP) cache to signal the line predictor monitoring the return predictor on whether to start snooping the return predictor for the next prediction. According to one embodiment, the bit may be referred to as Top Bit, with the term “Top” indicating that the line predictor may start snooping at the top of stack (TOS) of the RPS. According to another embodiment, the bit may be referred to as Bottom bit, indicating the line predictor snooping at the “bottom” of the TOS of the RPS. It is contemplated that the bit may be known with any variety of names indicating various characteristics of the bit. When signaled, the line predictor may start snooping the return predictor. According to one embodiment, snooping the return predictor may include reading of the next prediction from the return predictor.

According to one embodiment, when the bit is set, a subroutine return may be predicted to have occurred, in which case, the line predictor may select an address from the return predictor. According to one embodiment, the address selected from the return predictor may be referred to as the next prediction, which is the address of the subroutine return. According to another embodiment, if the bit is not set, the line predictor may select an address, e.g., a target address, from the target field of the LP Cache.

According to one embodiment, each line predictor cache entry may include the bit to indicate to the line predictor on whether to perform snooping of the return predictor. According to one embodiment, the line predictor may be coupled with the return predictor via a bus, and a multiplexer may be coupled with both the line predictor and the return predictor. According to another embodiment, the multiplexer may be included in the line prediction circuit. The combination of the bit, the bus, the multiplexer, and the line predictor described herein seek to improve the cost and performance of line prediction, by providing higher accuracy along with maintaining high bandwidth, which may lower cost and improve performance of a microprocessor.

According to one embodiment, the LP Cache may be coupled with the RPS having entries and a TOS pointer to indicate the status of the RPS. Stated differently, the TOS may be indicated by the TOS pointer. According to one embodiment, when an instruction is a call instruction (or a subroutine call), the return address, which may be the instruction following the subroutine call, may be pushed onto the RPS. When an instruction is a return instruction (or a subroutine return), the return address as indicated by the current TOS pointer may be popped from the RPS. According to one embodiment, when a line misprediction is detected, the current TOS pointer may be read and compared with the original TOS pointer, and the bit in the line predictor may be updated according to the comparison result.

According to one embodiment, a Front-End Next Fetch Program Counter (FE Next Fetch PC) Calculation Unit may perform the task of pushing onto and popping from the RPS. The line predictor, on the other hand, may perform the role of monitoring and snooping of the return predictor to read the next prediction or address from the return predictor. The extra bit, as mentioned above, included in the LP cache entry may be used to signal the line predictor on whether to snoop the return predictor.

According to one embodiment, the line predictor may monitor the RPS to check the current status of the RPS. For example, the line predictor may monitor the RPS to determine whether another instruction was found in the pipeline during the time when the last prediction was made by the line predictor and the prediction was calculated by the FE Next Fetch PC Calculation Unit. Such an instruction, if found, may change the status of the RPS, and if such an instruction is found, the line predictor may reset the bit to avoid further monitoring of the RPS. Furthermore, according to one embodiment, if a delay in return predictions results in a relative reduction of line prediction accuracy, the line predictor may use predictions from the target field of the LP Cache instead of using prediction from the return predictor.

In the following description, for the purposes of explanation, numerous specific details are set forth in order to provide a thorough understanding of the various embodiments of the present invention. It will be apparent, however, to one skilled in the art that the embodiments of the present invention may be practiced without some of these specific details. In other instances, well-known structures and devices are shown in block diagram form.

Importantly, the techniques detailed herein may conceptually operate at a layer above line prediction. Therefore, while embodiments of the present invention will be described with reference to line prediction algorithms employing tables, the method and apparatus described herein are equally applicable to other line prediction techniques.

Various steps of the embodiments of the present invention will be described below. The steps may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

Various embodiments of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, various embodiments of the present invention may also be downloaded as a computer program product, wherein the program may be transferred from a remote computer to a requesting computer by way of data signals embodied in a carrier wave or other propagation medium via a communication link (e.g., a modem or network connection).

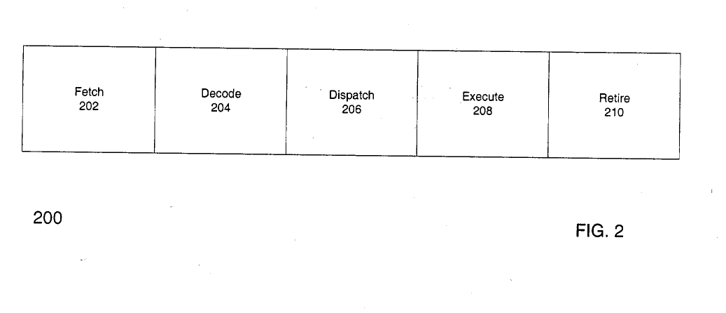

FIG. 2 is a block diagram illustrating a simplified instruction pipeline. According to this simplified example, the instruction pipeline 200 comprises five major stages 202-210. The five major stages are the fetch stage 202, the decode stage 204, the dispatch stage 206, the execute stage 208, and the writeback stage (also referred to as the retirement stage) 210. Briefly, during the first stage, the fetch stage 202, one or more instructions are retrieved from memory, and subsequently decoded during the decode stage 204. Then, the instructions are dispatched to the appropriate execution unit for execution during the dispatch stage 206 and execution takes place during the execute stage 208. Finally, as the decoded instructions complete execution, they are marked as being ready for retirement and are subsequently retired (e.g., their results are committed to the architectural registers) during the retirement stage 210.

Consequently, the fetch unit (not shown) at the head of the pipeline may provide the pipeline with a continuous flow of instructions, hence keeping the microprocessor busy. The fetch unit may keep the constant flow of instructions so the microprocessor does not have to stop its execution to obtain instructions from memory. Such fetching guarantees continuous execution, as long as the instructions are stored in order of execution. However, due to certain instructions, such as conditional instructions included in software loops or conditional jumps, instructions encountered by the fetch unit are not always presented in a sequence corresponding to the order of execution. Thus, such instructions may cause pipelined microprocessors to speculatively execute down the wrong path such that the microprocessor must later flush the speculatively executed instructions and restart at a corrected address.

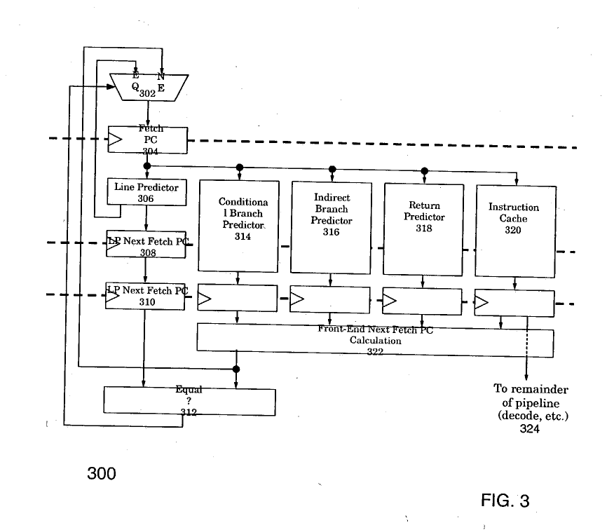

FIG. 3 is a block diagram illustrating an overview of front-end pipeline stages. Typically, in a pipelined processor, a line predictor 306 may sit at the beginning of the pipeline. The line predictor 306 may provide an initial prediction regarding which instructions to fetch next. The predictor's bandwidth, i.e., predictions per cycle, and accuracy need to be high enough to supply the processor's execution core with enough useful instructions.

As illustrated, the Fetch Program Counter (PC) 304 is presented to a conditional branch predictor 314, an indirect branch predictor 316, a return predictor 318, and an instruction cache 320. The Fetch PC may be coupled or looped with the line predictor 306. The Fetch PC 304 may access the instruction cache 320 to retrieve one or more instructions from the instruction cache 320, and the instruction may continue on to the rest of the pipeline 324, such as decode, register rename, etc. In the next cycle, an address may have to be presented to the instruction cache 320, and the next address may come from the line predictor 306. With every cycle, the line predictor 306 may present a new Fetch PC 304, which may then be presented to the instruction cache 320 and the various predictors 314-318. This prediction (or line predictor (LP) Next Fetch PC 308) may be used as the Fetch PC 304 in the following cycle. As illustrated, the thick horizontal dashed lines mark the cycle boundaries.

A typical line predictor 306 may not be accurate enough by itself and consequently, various predictors, such as the conditional branch 314, indirect branch 316, and return predictors 318 may be needed to supplement the line predictor 306. For example, the Front-End Next Fetch PC (FE Next Fetch PC) Calculation Unit 322 may receive a set of instructions, for example, instructions regarding a conditional branch, from the instruction cache 320, and receive a prediction regarding the condition branch from the conditional branch predictor 314 to determine whether the conditional branch is to be performed, making yet another prediction. Typically, a prediction made by the FE Next Fetch PC 322 is regarded as more accurate than the one made by the line predictor 306. This relatively accurate prediction made by the FE Next Fetch PC Calculation Unit 322 may then be compared with the relatively less accurate prediction of the line predictor 306.

If the predictions match, no further action may be required. If the predictions do not match, the front-end pipeline may be flushed. The more accurate prediction may then be loaded into the Fetch PC 304 via a multiplexer 302, which may restart the Front-End pipeline. Since the prediction from the FE Next Fetch PC Calculation Unit 322 is to be regarded as more accurate, in case of a mismatch, the entire line prediction mechanism may be directed according to the prediction from the FE Next Fetch PC Calculation Unit 322. Whenever the line predictor 306 is wrong, incorrect instructions may be fetched until the prediction from the FE Next Fetch PC Calculation Unit 322 indicates what the right prediction might be. Stated differently, whenever the line predictor 306 is wrong, a number of cycles may be wasted executing the wrong series of instructions until the next prediction is received from the FE Next Fetch PC Calculation Unit 322. Consequently, even a small number of mispredictions may result in a large penalty in terms of loss of bandwidth, as multiple cycles may be needed to produce one correct line prediction.

The conditional branch predictor 314, the indirect branch predictor 316, and the return predictor 318, as well as the instruction cache 320 may have multi-cycle latencies. For example, a latency of two cycles may mean that in the third cycle, the outputs of the conditional predictor 314, indirect predictor 316, return predictor 318, and instruction cache 320 may be fed into the FE Next Fetch PC Calculation Unit 322. The FE Next Fetch PC Calculation Unit 322 may then, as stated above, compute a more accurate prediction for the Next Fetch PC 308-310 than the prediction provided by the line predictor 306.

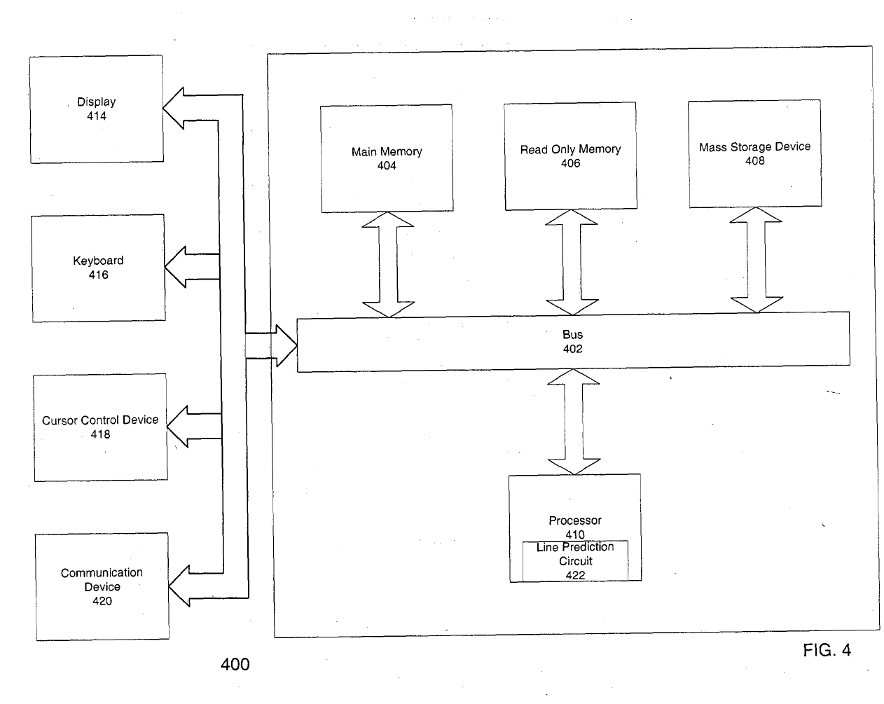

FIG. 4 is a block diagram illustrating an embodiment of a computer system. Computer system 400 includes a bus or other communication mechanism 402 for communicating information, and a processing mechanism such as processor 410 coupled with bus 402 for processing information. The processor 410 includes a novel line prediction circuit 422, according to one embodiment.

Computer system 400 further includes a random access memory (RAM) or other dynamic storage device 404 (referred to as main memory), coupled to bus 402 for storing information and instructions to be executed by processor 410. Main memory 404 also may be used for storing temporary variables or other intermediate information during execution of instructions by processor 410. Computer system 400 may include a read only memory (ROM) and/or other static storage device 406 coupled to bus 402 for storing static information and instructions for processor 410.

A data storage device 408 such as a magnetic disk or optical disc and its corresponding drive may also be coupled to computer system 400 for storing information and instructions. Computer system 400 can also be coupled via bus 402 to a display device 414, such as a cathode ray tube (CRT) or Liquid Crystal Display (LCD), for displaying information to an end user. For example, graphical and/or textual indications of installation status, time remaining in the trial period, and other information may be presented to the prospective purchaser on the display device 414. Typically, an alphanumeric input device 416, including alphanumeric and other keys, may be coupled to bus 402 for communicating information and/or command selections to processor 410. Another type of user input device is cursor control 418, such as a mouse, a trackball, or cursor direction keys for communicating direction information and command selections to processor 410 and for controlling cursor movement on display 414.

A communication device 420 is also coupled to bus 402. The communication device 420 may include a modem, a network interface card, or other well-known interface devices, such as those used for coupling to Ethernet, token ring, or other types of physical attachment for purposes of providing a communication link to support a local or wide area network, for example. In any event, in this manner, the computer system 400 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 400 will vary from implementation to implementation depending upon numerous factors, such as price constraints, performance requirements, technological improvements, and/or other circumstances.

It should be noted that, while the steps described herein may be performed under the control of a programmed processor, such as processor 410, in alternative embodiments, the steps may be fully or partially implemented by any programmable or hardcoded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

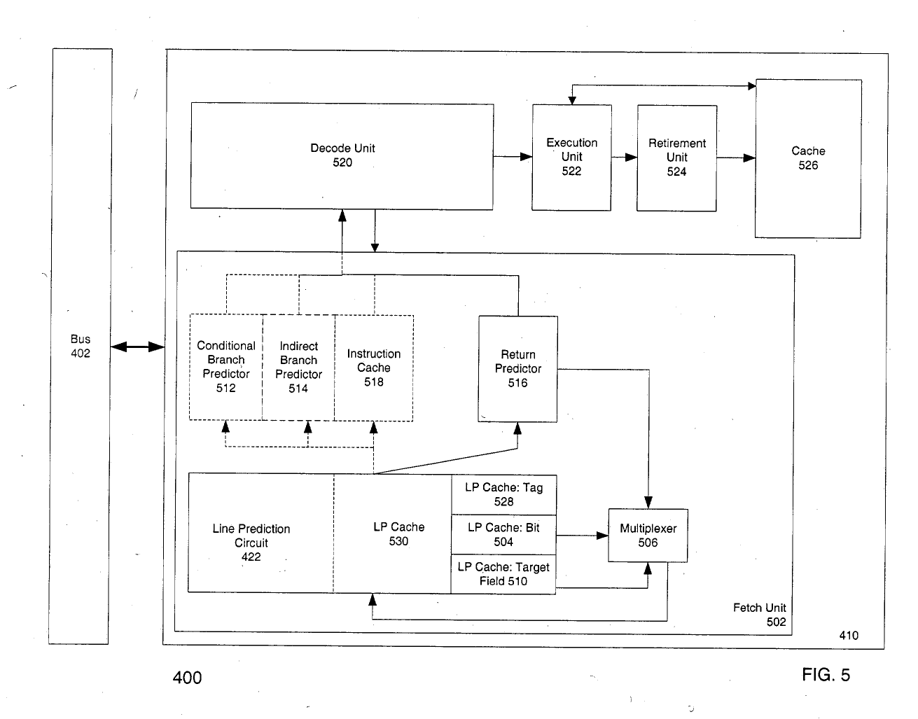

FIG. 5 is block diagram illustrating an embodiment of a processor having a line prediction circuit. In this example, as illustrated, the computer system 400 includes a processor 410. The processor 410, according to one embodiment, includes a fetch unit 502, a decode unit 520, an execution unit 522, a retirement unit 524, and a cache 526. According to one embodiment, as illustrated, the fetch unit 502 may be coupled with the decode unit 520, which may be coupled with the execution unit 522, which may be coupled with the retirement unit 524, which may be coupled with the cache 526, which may be coupled with the execution unit 522. The processor 410 may be coupled with a bus 402.

According to one embodiment, the fetch unit 502 may include a line prediction circuit (or line predictor) 422, a conditional branch predictor 512, an indirect branch predictor 514, a return predictor 516, an instruction cache 518, and a multiplexer 506. According to one embodiment, the fetch unit 502 may retrieve instructions and use the instruction pointer (IP) to continuously fetch based on the signals received from the line prediction circuit 422. According to one embodiment, the line prediction circuit 422 may predict which of the cache lines have branch instructions in them, and predict whether the branch instructions will be taken or not. The line prediction circuit 422 may also provide the next fetch address or the line predictor (LP) Next Fetch program counter (PC).

According to one embodiment, the next fetch address may come from a series of multiplexers including the multiplexer 506, which may be coupled with the return predictor 516 and the line prediction circuit 422. Although the multiplexer 506 is illustrated as being coupled with the return predictor 516 and the line prediction circuit 422; according to one embodiment, the multiplexer 506 may be included in the line prediction circuit 422. Stated differently, the multiplexer 506 may be a component of the line prediction circuit 422 rather than coupled with the line prediction circuit 422. The line prediction circuit 422 may also provide addresses for the target field 510, e.g., for the target instructions of the branches, of the line prediction circuit 422. According to one embodiment, such addresses may be used for predictions, instead of the snooping or reading predictions from the return predictor 516, particularly when the delayed return predictor 516 prediction may degrade line prediction accuracy. An address may refer to a value that identifies a byte within the memory or storage system of the computer system 400, and the fetch address may refer to an address used to fetch instruction bytes that are to be executed as instructions.

In this example, according to one embodiment, the line prediction circuit 422 may include a LP Cache 530, which may be coupled with the multiplexer 506, which may be coupled with the return predictor 516. The LP Cache 530 may include an extra bit 504, a target field 510, and tag 528. The bit 504 may be an extra bit or single bit included in each entry cached in the LP Cache, and the bit 504 may also be known as a top bit or bottom bit or the like. The multiplexer 506, according to one embodiment, may take two inputs and based on a single bit, select one of the two inputs. The bit 504 may be added to the LP Cache 530 of the line prediction unit 422; for example, the bit 504 may be added to each entry cached in the LP Cache 530.

According to one embodiment, the conditional branch predictor 512, the indirect branch predictor 514, and the return predictor 516 of the fetch unit 502 may be used to help the line prediction circuit 422. For example, predictions from the line predictor 422 may be verified to determine whether the instructions are, conditional or unconditional branch instructions or direct or indirect branch instructions or return instructions. Conditional branch instructions may be predicted using conditional branch predictor 512 based on, for example, the past behavior of the conditional branch instructions. A conditional branch instruction may select a target or sequential address relating to the conditional branch instruction. On the other hand, an unconditional instruction may cause the instruction fetching to continue at the target address. An indirect branch instruction, which may be conditional or unconditional, may generate a target address. Furthermore, conditional branch instructions may have static target addresses, while the indirect branch instructions may have variable target addresses.

A return instruction, according to one embodiment, may refer to an instruction having a target address corresponding to the instruction after the last or most recently executed call instruction. Call and return instructions may refer to branch instructions that are used to branch or jump to and return from subroutines. A subroutine may refer to one or more instructions. For example, when a call instruction is executed, the processor 410 may branch or jump to a target address where the subroutine begins, while the termination of a subroutine by a return instruction may cause the processor 410 to branch or jump back to the return address indicated by a return prediction stack (RPS) in the return predictor 516.

According to one embodiment, the return predictor 516 may include a RPS having return addresses including both the predicted and actual return addresses. The status of the top of the stack (TOS) may be indicated by a TOS pointer. According to one embodiment, when a line misprediction is detected, the TOS pointer may be read to compare the original TOS pointer to the current TOS pointer. If the two TOS pointers (i.e., the original TOS pointer and the current TOS pointer) are the same, there may not be any intervening call or return, and the bit 504 may be reset or set depending on whether the instruction contains a return. However, if the original TOS pointer and the current TOS pointer are determined to be not the same, there may be an intervening call or return, and the line prediction circuit 422 may be directed to use the last-time prediction from the target field 510 of the LP Cache 530 of the line prediction circuit 422, instead of the prediction from the return predictor 516, by resetting the bit 504, regardless of whether the instruction contains a return.

Returning to the fetch unit 502, according to one embodiment, the fetching process of the fetch unit 502 may be interrupted if a line misprediction is encountered, because the next instruction following the line misprediction may have to be resolved before any more instructions can be fetched. The line prediction circuit 422 may predict the target address of the line based upon whether or not the cache line is expected to contain a predicted taken branch. The line prediction unit 422 may provide the address to the fetch unit 502 to allow the fetch unit 502 to continue fetching instruction data.

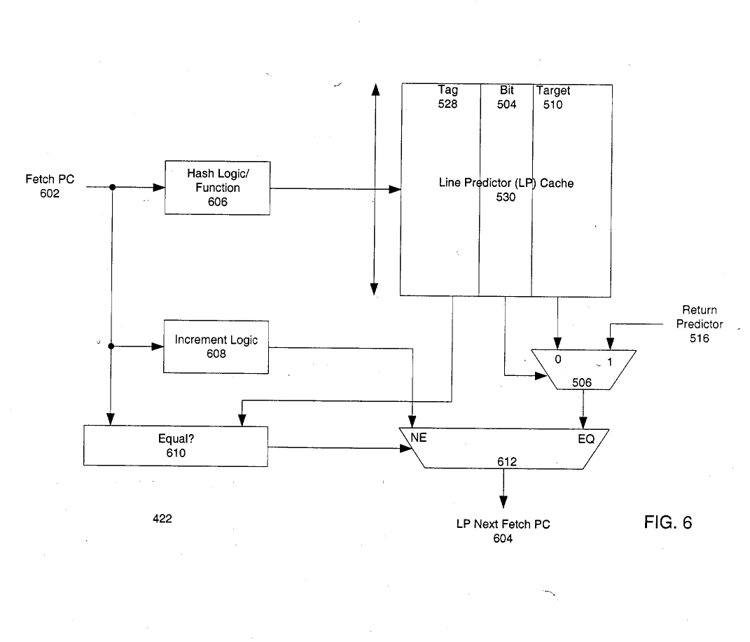

FIG. 6 is a block diagram illustrating an embodiment of a line prediction circuit. As illustrated, the line prediction circuit (or line predictor) 422, according to one embodiment, includes a line predictor (LP) Cache 530, Hash logic/function 606, Increment logic 608, multiplexer 506 coupled with a return predictor 516 and the LP Cache 530. The LP Cache 530 may include a tag 528, a target field 510, and a bit 504. The bit 504 may be a single bit or an extra bit included in each entry cached in the LP Cache 530, and the bit 504 may also be known as a top bit or bottom bit.

Since many of the mispredictions are caused by subroutine returns, according to one embodiment, the line predictor 422 may be used to guide the front line of the pipeline. For example, according to one embodiment, the line predictor 422 may monitor the return predictor 516 by, according to one embodiment, monitoring the return prediction stack (RPS) of the return prediction. A return predictor 516 may provide target addresses of subroutine returns to the fetch unit, such as the fetch unit 502 of FIG. 5, so that when the fetch unit 502 encounters a subroutine return, the fetch unit 502 may avoid interrupting the constant flow of instructions to the microprocessor's execution core by redirecting fetch to the subroutine return's target address, resulting in increased machine performance and efficiency. A return predictor 516 may include a hardware implementation of a stack, that has a subroutine return's target address pushed on the stack when the fetch unit 502 encounters the subroutine call that corresponds to the subroutine return, and that has the target address of the subroutine return popped from the stack when the fetch unit 502 encounters the subroutine return. According to one embodiment, a line prediction mechanism may reduce the number of line mispredictions, resulting in increased machine performance and efficiency, by monitoring and/or snooping a return predictor 516 so that the line prediction mechanism may use target addresses stored in the return predictor 516 for producing line predictions.

According to one embodiment, the RPS may include return addresses including both the predicted and actual return addresses. Furthermore, the line predictor 422 may snoop the return predictor 516 to read the next prediction from the return predictor 516 when signaled by the bit 504. Stated differently, the line predictor 422 may snoop the return predictor 516 to determine whether a subroutine return may be predicted, i.e., whether the next non-sequential prediction is due to a subroutine return. According to one embodiment, the bit 504 may be used to help the line predictor 422 determine whether and when to snoop the return predictor 516. The line predictor 422 may, however, continue to monitor the return predictor 516.

According to one embodiment, the top of the stack (TOS) of the RPS of the return predictor 516 may be indicated by a TOS pointer. When an instruction is a call instruction (or a subroutine call), the return address, which is the instruction following the subroutine call, may be pushed onto the RPS. When an instruction is a return instruction (or a subroutine return) the return address as indicated by the current TOS pointer may be popped from the RPS. When a line misprediction is detected, the current TOS pointer may be read and compared to the original TOS pointer, and the bit 504 in the line prediction may be updated according to the comparison result.

According to one embodiment, the line predictor 422 may monitor the TOS. If a subroutine is exited, the line predictor 422 may check the bit 504, and if the bit 504 is set, indicating a subroutine return, the line predictor 422 may select an address from the return predictor 516. If the bit 504 is not set, the line predictor 422 may select an address from the target field 510 of the LP Cache 530. Stated differently, if the bit 504 is set, an address from the return predictor 516 may be selected, i.e., the next prediction selected from the return predictor 516 is the address of the subroutine return. If the bit 504 is not set, a target address may be selected from the target field 510 of the LP Cache 530.

According to one embodiment, each entry in the LP Cache 530 may include the bit 504. On a LP Cache 530 miss, the line may be predicted to be sequential, and no further action may be necessary. On a LP Cache 530 hit, the target field 510 of the LP Cache 530 may provide the LP Next Fetch program counter (PC) 604 if the bit 504 is not set, and the return predictor 516 may provide the LP Next Fetch PC 604 if the bit 504 is set. The bit 504 may be used to monitor the return predictor 516 when the return predictor 516 may provide LP Next Fetch PC 604. According to one embodiment, if the line responsible for the misprediction contains a return, the bit 504 may be set. Otherwise, the bit 504 may be reset.

According to one embodiment, the Front-End Next Fetch Program Counter (FE Next Fetch PC) Calculation Unit, such as the FE Next Fetch PC Calculation Unit 322 of FIG. 3, may be used to determine whether to push a return address to or pop a return address from the RPS. Stated differently, the FE Next Fetch PC Calculation Unit may also be used to passively monitor the RPS, but also used to actively modify the RPS, when necessary. The line predictor 422, on the other hand, may perform a passive role by monitoring and snooping the return predictor 516.

According to one embodiment, the line predictor 422 may also continue to monitor the RPS to detect those instructions within the pipeline that may push or pop the RPS, rendering the address received from the return predictor 516 to be wrong. As the line predictor 422 monitors the RPS, according to one embodiment, the line predictor 422 may determine the current status of the RPS, i.e., to know what is currently contained in the RPS. One way of determining the current status of the RPS may be to check the current TOS pointer. If the status of the RPS changes from the time-the prediction was made by the line predictor 422 to the time the prediction was calculated by the FE Next Fetch PC Calculation Unit 322, the prediction from the RPS might be characterized as wrong. In that case, the bit 504 may be reset to avoid further monitoring of the RPS.

Stated differently, according to one embodiment, between the time the line predictor 422 checks the RPS and the time the prediction is calculated by the FE Next Fetch PC Calculation Unit 322 there may be a delay, and during that delay, another instruction may cause the RPS to change. If there is another instruction in the pipeline causing a change to the RPS, then the line predictor 422 may stop checking the RPS.

According to one embodiment, the return predictor 516 may be updated at the same time as the line predictor 422. In some cases, the updating of the return predictor 516 may be delayed for a few cycles; for example, the return predictor update may not occur until the third cycle. If there are subroutine calls or subroutine returns within these few cycles, any return prediction used by the line predictor 422 may be stale and is likely to be incorrect.

According to one embodiment, if these delayed return predictor updates were to degrade line prediction accuracy, the line predictor 422 may be directed to select a prediction from the target field 510 of the LP Cache 530 rather than using a prediction from the return predictor 516. To accomplish that, the current TOS pointer may be read when a line prediction is made. When a line misprediction is detected, the original TOS pointer may be compared to the return predictor's 516 current TOS pointer. If the original TOS pointer and the current TOS pointer are the same, there may not be an intervening subroutine call or return, and the bit may be reset or set depending on whether the line contains a return. If the original TOS pointer and the current TOS pointer are not the same, there may be an intervening subroutine call or return, in which case the line predictor 422 may be directed to select the last-time prediction from the target field 510 by resetting the bit 504, regardless of whether the line contains a return.

According to one embodiment, on a line misprediction, the tag for the line prediction and the target, e.g., the prediction from the FE Next Fetch PC Calculation Unit, may be written into the LP Cache 530. A tag may either be a full tag or a partial tag. Partial tags may be cheaper to implement, and, with very few bits, they may approach the accuracy of full tags.

According to one embodiment, the Hash logic 606 may take the Fetch PC 502 and hash it down to the number of bits required, for example, ten (10), to access the LP Cache 530. One assumes, for example, the instructions to be four (4) bytes long and stored at naturally aligned addresses, so that the lower two (2) bits of all PCs, tags 528, targets 510, etc., are 0 and are ignored by the hardware. An instruction cache, such as instruction cache 518 of FIG. 5, for example, may be one hundred and twenty-eight (128) kilobytes, direct-mapped, with an eight (8) byte line size.

According to one embodiment, instruction cache line offset bit, (e.g., bit two (2)) and one (1) bit (e.g., bit seventeen (17)) above the instruction cache index bits, (e.g., bits two-seventeen (2-17)), may be stored in the target field 510, even though these two bits, (e.g., bits two (2) and seventeen (17)), may not be needed to begin accessing the instruction cache 518. Including these bits in the hash function 606, however, may improve line prediction accuracy, and, since LP Next Fetch PC 604 may become Fetch PC 602 in the following cycle, the bits may be stored in the target field 510 in order to be included in the hash function 606. However, the bits may not be needed for correct functioning of the line predictor 422, and may be removed from the target field 510 and hash function 606 for some loss in prediction accuracy.

According to one embodiment, a minimum requirement may be set for the bits of the instruction cache line addresses to match, e.g., the bits from the LP Next Fetch PC prediction and the FE Next Fetch PC Calculation Unit prediction to match, even if the offset bits for the instruction within the line do not match. For example, ignoring the instruction cache line offset bits when performing the match, a line may be correctly predicted if the instruction cache line addresses match, but the offsets for the instruction within the lines do not match. However, to have additional requirements for a match, the cache line offset bits may also be required to match. In this example, the cache line offset bits may be ignored.

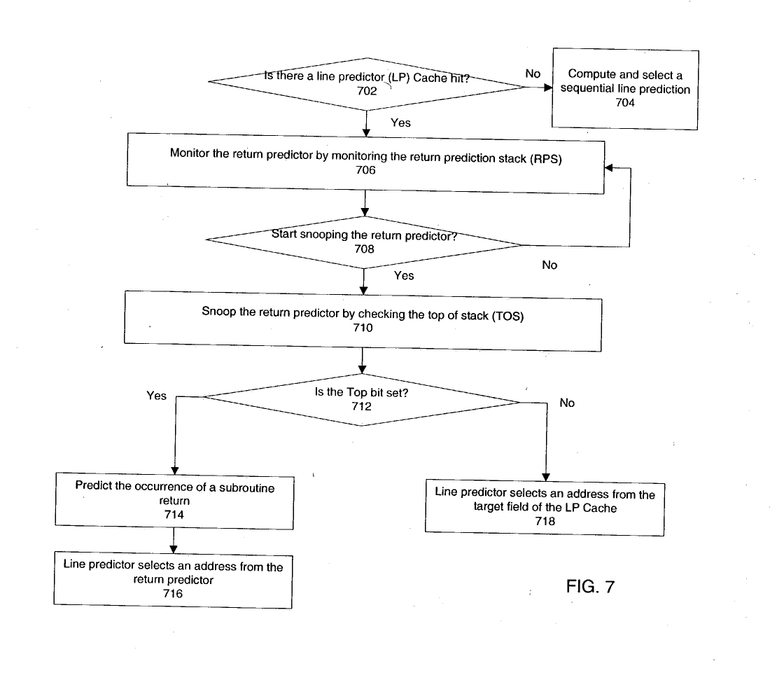

FIG. 7 is a flow diagram illustrating an embodiment of a line prediction process. Since many of the mispredictions are caused by subroutine returns, according to one embodiment, the line predictor may be used to guide the front line of the pipeline by monitoring and snooping the return predictor to determine whether a subroutine return may be predicted, i.e., whether the next non-sequential prediction is due to a subroutine return. According to one embodiment, a bit may be used to help the line predictor determine whether and when to snoop the return predictor. The line predictor may, however, continue to monitor the return predictor.

According to one embodiment, the return predictor may include a return prediction stack (RPS) having return addresses including both the predicted and actual return addresses. The top of the stack (TOS) may be indicated by a TOS pointer. The line predictor may monitor the current TOS pointer.

First, according to one embodiment, determine whether there is a hit in the line predictor (LP) Cache at decision block 702. If there is no LP Cache hit, a sequential line prediction may be computed and selected at processing block 704. In case of a LP Cache hit, the line predictor may monitor the return predictor by monitoring the RPS at processing block 706. At decision block 708, determine whether snooping of the return predictor is to be performed. According to one embodiment, snooping of the return predictor includes reading of a prediction, such as the next prediction, from the return predictor by the line predictor. According to one embodiment, a single bit may be included in the LP Cache of the line predictor, and the bit may direct the line predictor on whether the snooping of the return predictor is to be performed. The single bit or extra bit may be included in each entry cached in the LP Cache, and the single bit may also be known as a top bit or bottom bit. The line predictor may snoop the return predictor at processing block 710. Snooping of the return predictor may be performed by checking the TOS. At decision block 712, determine whether the bit is set.

If the bit is set, a subroutine return may be predicted to have occurred at processing block 714. If a subroutine return has occurred, the line predictor may select an address from the return predictor at processing block 716. If the bit is not set, the line predictor may select an address from the target field of the LP Cache at processing block 718. Stated differently, if the bit is set, an address from the return predictor may be selected, i.e., the next prediction selected from the return predictor is the address of the subroutine return. If the bit is not set, a target address may be selected from the target field of the LP Cache.

According to one embodiment, when an instruction is a call instruction (or a subroutine call), the return address, which is the instruction following the subroutine call, may be pushed onto the RPS. When an instruction is a return instruction (or a subroutine return) the return address as indicated by the current TOS pointer may be popped from the RPS. When a line misprediction is detected, the current TOS pointer may be read and compared to the original TOS pointer, and the bit for the line prediction may be updated according to the comparison result.

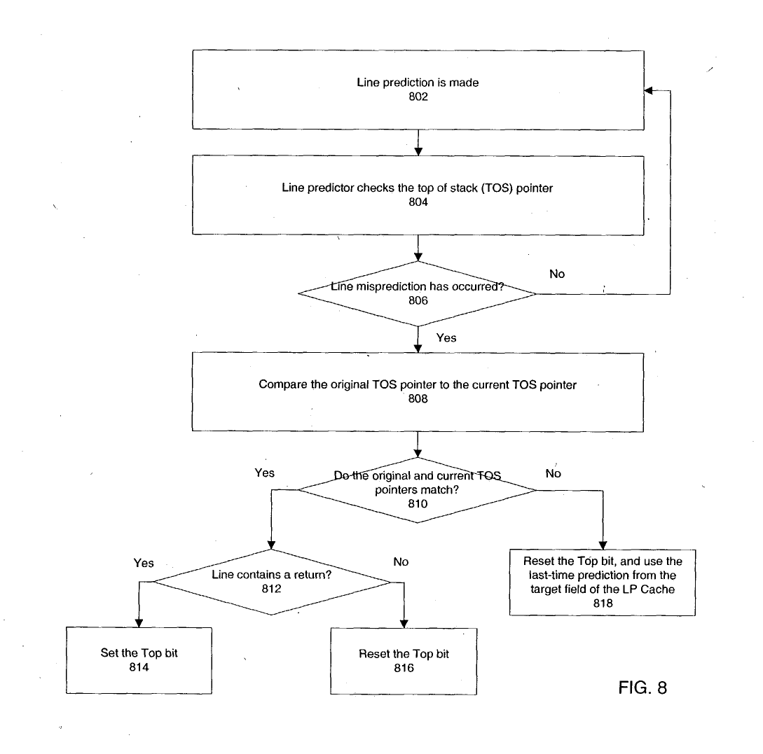

FIG. 8 is a flow diagram illustrating an embodiment of a process when a delay in return predictor updates may be experienced. As discussed with regard to FIG. 6, the updating of the return predictor may be delayed by a few cycles. If the updates begin to degrade the line prediction accuracy, or when there may be outstanding return predictor updates, the line predictor may be directed to select predictions from the target field of the line predictor (LP) Cache instead of the predictions from the return predictor.

First, a line prediction is made at processing block 802. The line predictor may check the return predictor's top of stack (TOS) pointer at processing block 804. At decision block 806, whether a line misprediction has occurred is determined. If no misprediction is detected, the process continues at processing block 802. If a misprediction is detected, the original TOS pointer is compared with the current TOS pointer at processing block 808.

At decision block 810, whether the original TOS pointer and the current TOS pointer are the same is determined. If the original TOS pointer and the current TOS pointer are determined to be the same, whether the line contains a return is determined at decision block 812. The bit may be set if the line contained a return at processing block 814, and the bit may be reset if the line did not contain a return at processing block 816. If the original TOS pointer and the current TOS pointer are determined to be not the same, the line predictor may be directed to use the last-time prediction from the target field of the LP Cache by resetting the bit, regardless of whether the line contained a return at processing block 818.

In the foregoing specification, the present invention has been described with reference to specific embodiments thereof. It will, however, be evident that various modifications and changes may be made thereto without departing from the broader spirit and scope of the various embodiments of the present invention. The specification and drawings are, accordingly, to be regarded in an illustrative rather than a restrictive sense.

What is claimed is:

1. A method, comprising:
monitoring a return predictor; and
snooping the return predictor, wherein snooping comprises reading a prediction from the return predictor.

2. The method of claim 1, further comprising:
determining whether a bit is set; and
using the prediction if the bit is set.

3. The method of claim 1, wherein the monitoring comprises monitoring a return prediction stack (RPS) of the return predictor, the RPS having return addresses including at least one of the following: predicted return addresses and actual return addresses.

4. The method of claim 1, wherein the prediction from the return predictor includes a predicted return address of the predicted return addresses.

5. The method of claim 2, further comprising:
predicting a subroutine return if the bit is set; and
selecting an address from the return predictor.

6. The method of claim 1, further comprises selecting an address from a cache of a line predictor if the bit is not set.

7. A method, comprising:
detecting a line prediction;
detecting a line misprediction; and
setting a bit if the line misprediction comprises a return.

8. The method of claim 7, further comprising:
detecting whether the line misprediction comprises the return; and
resetting the bit if the line misprediction comprises an indication other than the return and an original Top of Stack (TOS) pointer is equal to a current pointer; and
resetting the bit if the original TOS pointer is not equal to a current TOS pointer.

9. The method of claim 8, further comprises selecting a return address from a return predictor if the bit is set, wherein the return predictor comprises a return prediction stack (RPS), the RPS having return addresses including at least one of the following: predicted return addresses and actual return addresses.

10. The method of claim 7, further comprises selecting a target address from a target field of a cache of a line predictor if the bit is reset.

11. A processor, comprising:
a line prediction circuit; and
a return predictor having a one or more return addresses, the return predictor coupled to the line prediction circuit, wherein the line prediction circuit to snoop the return predictor to predict a return address from the one or more return addresses.

12. The processor of claim 11, wherein the line prediction circuit comprises:
a cache having a bit to direct the line prediction circuit on whether to snoop the return predictor; and
a multiplexer to transmit data between the line prediction circuit and the return predictor, the multiplexer coupled to the return predictor.

13. The processor of 12, wherein the cache further comprises a target field having one or more target addresses.

14. The processor of claim 11, wherein the return predictor further comprises a return prediction stack (RPS) to hold the one or more return addresses, the one or more return addresses including at least one of the following: one or more predicted return addresses and one or more actual return addresses.

15. The processor of claim 11, wherein the snooping the return predictor comprises selecting the return address from the one or more return addresses by first monitoring a top of stack (TOS) of the RPS.

16. A line predictor, comprising:
a cache having a bit to direct the line predictor on whether to snoop a return predictor; and
a multiplexer to select an input from a plurality of inputs using the bit, the multiplexer coupled to the return predictor.

17. The line predictor of claim 16, further comprising:
hash logic to hash Fetch Program Counter (Fetch PC) value to a number of bits necessary to access the cache; and
increment logic to use the Fetch PC value to compute an address of a next sequential instruction cache line.

18. The line predictor of claim 16, wherein the return predictor comprises a return prediction stack (RPS) having one or more return addresses.

19. A system, comprising:
a storage medium; and
a processor coupled to the storage medium, the processor having a fetch unit to retrieve instruction data for processing, the fetch unit having
a line prediction circuit; and
a return predictor having a one or more return addresses, the return predictor coupled to the line prediction circuit, wherein the line prediction circuit to snoop the return predictor to predict a return address from the one or more return addresses.

20. The system of claim 19, the line prediction circuit comprises:
a cache having a bit to direct the line prediction circuit on whether to snoop the return predictor; and
a multiplexer to transmit data between the line prediction circuit and the return predictor, the multiplexer coupled to the return predictor.

21. The system of claim 19, wherein the return predictor comprises a return prediction stack (RPS) to hold the one or more return addresses.

22. The system of claim 19, wherein the snooping the return predictor comprises selecting the return address from the one or more return addresses by first monitoring a top of stack (TOS) of the RPS.

23. A machine-readable medium having stored thereon data representing sequences of instructions, the sequences of instructions which, when executed by a machine, cause the machine to:
monitor a return predictor; and
snoop the return predictor, wherein snooping comprises reading a prediction from the return predictor.

24. The machine-readable medium of claim 23, wherein the sequences of instructions further cause the machine to:
determine whether a bit is set; and
use the prediction if the bit is set.

25. The machine-readable medium of claim 23, wherein the monitoring comprises monitoring a return prediction stack (RPS) of the return predictor, the RPS having return addresses including at least one of the following: predicted return addresses and actual return addresses.

26. The machine-readable medium of claim 23, wherein the prediction from the return predictor includes a predicted return address of the predicted return addresses.

27. The machine-readable medium of claim 23, wherein the sequences of instructions further cause the machine to:
predict a subroutine return if the bit is set; and
select an address from the return predictor.

28. A machine-readable medium having stored thereon data representing sequences of instructions, the sequences of instructions which, when executed by a machine, cause the machine to:
detect a line prediction;
detect a line misprediction; and
set a bit if the line misprediction comprises a return.

29. The machine-readable medium of claim 28, wherein the sequences of instructions further cause the machine to:
detect whether the line misprediction comprises the return;
reset the bit if the line misprediction comprises an indication other than the return and an original Top of Stack (TOS) pointer is equal to a current TOS pointer; and
reset the bit if the original TOS pointer is not equal to a current TOS pointer.

30. The machine-readable medium of claim 29, wherein the sequences of instructions further cause the machine to:
select a return address from a return predictor if the bit is set, wherein the return predictor comprises a return prediction stack (RPS), the RPS having return addresses including at least one of the following: predicted return addresses and actual return addresses; and
select a target address from a target field of a cache of a line predictor if the bit is reset.
